(19) United States
(12) Patent Application Publication
(10) Pub. No.: US 2007/0147367 A1
(43) Pub. Date: Jun. 28, 2007

(54) VoIP communication remote control system and remote controller thereof

(76) Inventors: Jin-Bo Hwang, Shanghai (CN); Qi-Ming Yang, Shanghai (CN); Hui Li, Shanghai (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/505,983

(22) Filed: Aug. 18, 2006

(30) Foreign Application Priority Data
Dec. 23, 2005 (TW) 94222561

(51) Int. Cl. H04L 12/56

(52) U.S. Cl. 370/389; 370/401

(57) ABSTRACT

The present invention provides a VoIP communication remote control system. A network signal processing unit retrieves a network data packet from an Internet, the network data packet is de-packeted by a central processing unit to obtain an encoded visual signal and an encoded income-call data stream, after the encoded visual signal is decoded by the encode/decode module, an image data stream and an audio data stream are generated, the encoded income-call data stream is wirelessly radiated, and the medium playing unit receives and plays the image data stream and the audio data stream. The remote controller is wirelessly receives the encoded income-call data stream, the encoded income-call data stream is transmitted to the speech receive/transmit unit and played after decoded by the data conversion unit, the control unit wirelessly transmits a control command to the central processing unitto control the medium playing unit through the encode/decode module.

### BACKGROUND OF THE INVENTION

1. Field of the Invention

The present invention is related to a VoIP communication remote control system and remote controller thereof, and more particularly, to an application of combining remote controller, AV terminal device and VoIP so that a remote controller can be use to remotely control a digital TV and also can be used as a VoIP.

2. Description of Related Art

In the currently used analog TV, the image signal is varied continuously and NTSC device is adopted. According to the advancement of visual signal compression, digital TV has a finer image and more lifelike colors and also provides a high quality audio effect (Dolby AC3) so that it has gradually become the main stream in family TV. For watching the digital TV, a STB (Set Top Box) device for converting visual signal is needed.

The STB possesses the functions of signal receiving, demodulation, demultiplex, decompression, decryption, and visual signal conversion and can be integrated into the digital TV or coupled to TV by cable. After adopting the STB, TV can have the functions of internet access, video on demand, video conference, satellite receiving and digital program receiving. The STB can be controlled by a remote controller and the remote controller can control the function of the STB for achieving a convenience.

Currently, the use of ADSL broadband network is really popular. Except the application in Internet accessing, the ADSL broadband network also can be used in VoIP (Voice Over IP), which is already a developing point for many Internet companies. In VoIP, the speech signal is compressed into data packet and transmitted based on the IP (Internet Protocol), that is, the speech is transmitted through the open Internet. Through the Internet, it not only can achieve a real time speech service, also can connect to users all over the world without using the traditional PSTN (Public Switched Telephone Network) for the long distance phone conversation so that it can save the telephone bill.

In a digital family, the STB is always adopted with a remote controller for the operation of channel selection and other functions such as internet access, video on demand, video conference, satellite receiving and digital program receiving and enjoy a high quality video effect, and in communication, the VoIP is used for long distance conversation for saving fees. However, these two applications have to be achieved by different products which may increase spends on digital product and also the occupied space.

### SUMMARY OF THE INVENTION

The present invention provides a remote control system and remote controller for a VoIP. The remote control system combines a remote controller, video terminals and VoIP so that the remote controller can remotely control the channel selection of the digital TV and other functions and also, through the VoIP, can dial and receive the internet phone simultaneously.

The present invention provides a VoIP communication remote control system includes a network signal processing unit, a central processing unit, an encode/decode module, a medium playing unit, a remote controller, and a corresponding wireless module. The network signal processing unit retrieves a network data packet from an Internet, the network data packet is de-packeted by the central processing unit to obtain an encoded visual signal and an encoded income-call data stream, the encoded income-call data stream is wirelessly radiated, after the encoded visual signal is decoded by the encode/decode module, an image data stream and an audio data stream are generated, and the medium playing unit receives and plays the image data stream and the audio data stream. The remote controller includes a speech receive/transmit unit, a data conversion unit, a control unit, and a wireless module. The remote controller is wirelessly receives the encoded income-call data stream, the encoded income-call data stream is transmitted to the speech receive/transmit unit and played after decoded by the data conversion unit, the control unit wirelessly transmits a control command to the central processing unit through the data conversion unit, and the central processing unit controls the medium playing unit through the encode/decode module.

Furthermore, the remote controller retrieves a response signal through the speech receive/transmit unit, the response signal is converted into a response data stream after being encoded by the data conversion unit, the remote controller wirelessly transmits the response data stream to the central processing unit, and after the central processing unit packets the response data stream, it is transmitted to the internet through the network signal processing unit for achieving the VoIP communication.

The present invention provides a remote controller used in a VoIP communication remote control system for wirelessly communicating data with a terminal STB (Set Top Box) as well as dialing VoIP and remote controlling digital TV including a data conversion unit, a speech receive/transmit unit, a control unit, a display unit, a character input unit and a wireless unit. The data conversion unit wirelessly communicates data with the STB and executes a data conversion; the speech receive/transmit unit receives and plays a encoded income-call data stream as well as retrieves a response message from outside and transmits thereof to the data conversion unit, the control unit is connected to the data conversion unit for outputting a remote command to the data conversion unit, the display unit receives and displays an image data stream from the data conversion unit, and the character input unit outputs a character data stream and transmits thereof to the data conversion unit through the control unit.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view showing a remote control system for VoIP communication according to the present invention;

FIG. 2 is a circuit block showing the remote control system for VoIP communication according to the present invention; and

FIG. 3 is a schematic view showing the circuits of the remote controller in the present invention.

### DETAILED DESCRIPTION OF PREFERRED EMBODIMENTS

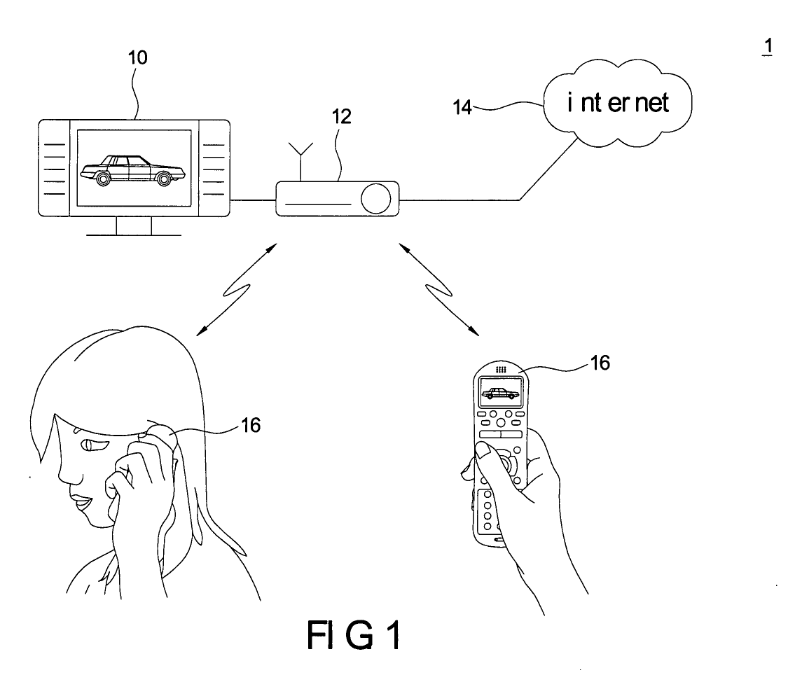

Please refer to FIG. 1, which is a schematic view showing a remote control system for VoIP communication according to the present invention. The VoIP communication remote control system 1 of the present invention has a STB (Set Top Box) 12, which has the functions of general signal receiving, demodulation, demultiplex, decompression, decryption, and visual signal conversion and also the function of VoIP at the same time. The STB 12 is connected to a medium playing unit 10 and an Internet 14, and the data of the STB 12 is communicated with a remote controller 16 through Wi-Fi, which is a wireless technology. The STB 12 is remotely controlled by the remote controller 16 for receiving a TV signal from the Internet 14. After the TV signal is demodulated, demultiplexed, decompressed, decrypted, and converted, it can be played on the medium playing unit 10. The medium playing unit 10 can be a digital TV (DTV). Accordingly, the remote controller 12 can remotely control the STB 12 to operate the channel selection and other functions of digital TV so as to achieve the internet access through digital TV, VOD (video on demand), video conference, satellite receiving, and digital program receiving.

Through the VoIP function of the STB 12, a two-way communication with a terminal can be achieved by Internet 14. Here, a communication device (not shown) is mounted in the remote controller 16 so that the user can use the communication device of the remote controller 16 to achieve a two-way communication with a persona at terminal through the STB 12 and the Internet 14.

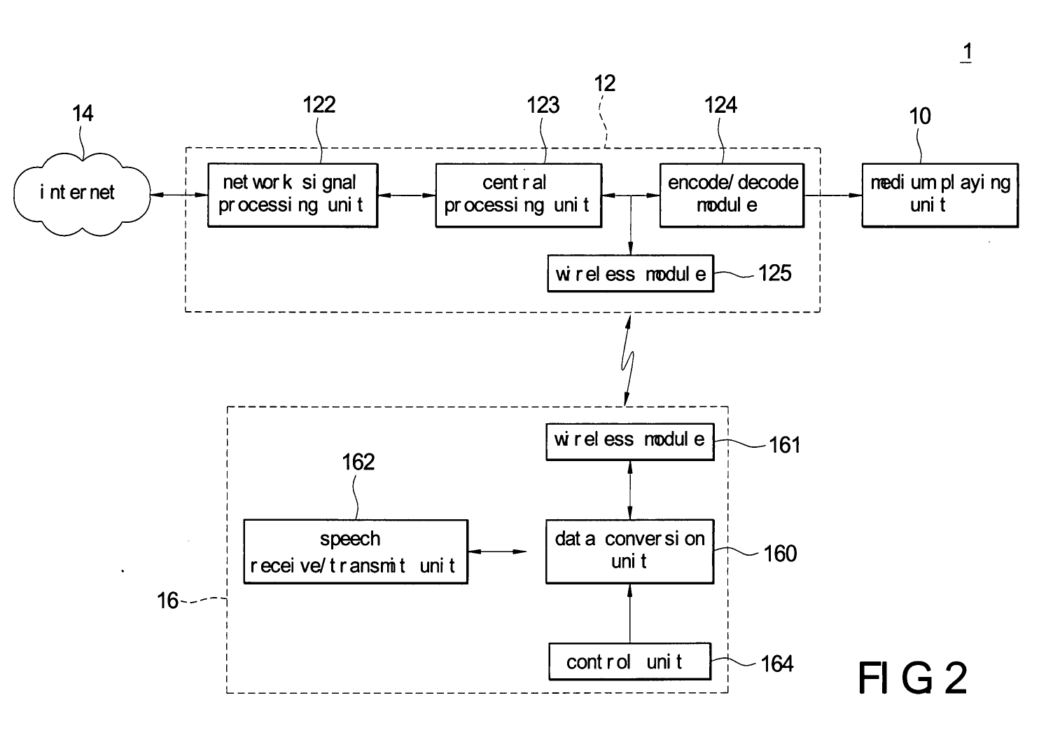

Please refer to FIG. 1 and 2, which is a circuit block showing the remote control system for VoIP communication according to the present invention. In this VoIP remote control system 1, the STB 12 includes: a network signal processing unit 122, a central processing unit 123 and an encode/decode module 124, wherein the network signal processing unit 22 is Realtek8019, the central processing unit is the IC designed by Freescale, named MPC8248, and the encode/decode module 124 is the IC designed by Sigma Design, named EM8620. The wireless module adopts the IC of Broadcom, named BCM4318.

The network processing unit 122 uses an Ethernet interface (not shown) or an asynchronous serial interface (not shown) to retrieve a network data packet from Internet 14, wherein the network data packet is de-packeted by the central processing unit 123 to obtain an encoded visual signal and an encoded income-call data stream and the encoded income-call data stream is outputted by radiation via the wireless module 125. After the encoded visual signal is decoded by the encode/decode module 124, an image data stream and an audio data stream are obtained. After the encode/decode module 124 utilizes a video compression technology to decode the image data stream and the audio data stream, the data will be outputted in analog and digital forms.

The medium playing unit 10 receives and plays the decoded image data stream and audio data stream. The remote controller 16 includes a speech receive/transmit unit 162, a data conversion unit 160, a control unit 164 and a wireless module 161. The remote controller 16 receives the speech data stream through wireless communication. The speech data stream is transmitted to the speech receive/transmit unit 162 and played thereby after being decoded by the data conversion unit 160. The control unit 164 wirelessly transmits the remote command to the central processing unit 123 through the data conversion unit 160, and the central processing unit 123 will act properly and control the medium playing unit 10 through the encode/decode module 124. The data conversion unit 160 and the control unit 164 of the remote controller 16 can be integrated in an IC, and in the present invention, the IC is designed by Intel, named PXA270. The wireless module 161 of the remote controller 16 is IC of Broadcom, named BCM4318.

Again, please refer to FIG. 2. The remote controller 16 can further retrieve a response signal through the speech receive/transmit unit 162. The response signal is converted into a response data stream after being encoded by the data conversion unit 160. The remote controller 16 wirelessly transmits the response data stream to the central processing unit 123, and after the central processing unit 123 packets the response data stream, it is transmitted to Internet 14 through the network signal processing unit 122 for achieving a VoIP communication.

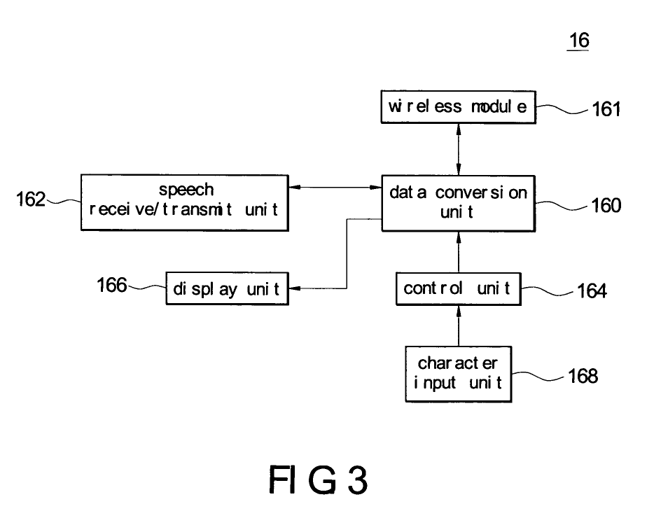

Please refer to FIGS. 2 and 3, which is a schematic view showing the circuits of the remote controller in the present invention. The remote controller 16 further includes: a display unit 166 and a character input unit 168. The data conversion unit 160 communicates data with the STB 12 through the wireless communication module 161 and executes data conversion. The speech receive/transit unit 162 receives and plays the income-call data stream from the data conversion unit 160 and transmits the response signal retrieved from the outside to the data conversion unit 160. The control unit 164 is connected to the data conversion unit 160 and may output a remote command to the data conversion unit 160. The display unit 166 receives and displays the image data stream from the data conversion unit 160. The character input unit 168 outputs a character data stream which is transmitted to the data conversion unit 160 through the control unit 164.

Please refer to FIGS. 2 and 3. The remote controller 16 wirelessly communicates data with the terminal STB 12, dials the VoIP and remotely controls the digital TV. The data conversion unit 160 receives remote command from the control unit 164 and transmits the remote command to the central processing unit 123 through the wireless module 161 and 125. The central processing unit 123 acts properly (eg., sends content request) and transmits the new retrieved data, which is decoded by the encode/decode module 124, to the medium playing unit 10 for achieving the channel selection and other functions, such as internet access, video on demand, video conference, satellite receiving and digital program receiving. At the same time, the image data stream and the audio data stream generated by the operation of the encode/decode module 124 are further wirelessly transmitted to the display unit 166 and the speech receive/transmit unit 162, respectively and synchronously. Therefore, the display unit 166 of the remote controller 16 can synchronously display the data which is also splayed by the medium playing unit 10.

The remote controller 16 utilizes the character input unit 168 to edit a character data stream and wirelessly transmits the character data stream to the central processing unit 123. After the central processing unit 123 packets the character data stream, it is transmitted to the Internet 14 through the network signal processing unit 122 so as to achieve an instant messenger (IM).

Sum up, the present invention provides a remote control system for VoIP communication and a remote controller which combine the functions of remote control, video terminal and internet phone communication so that the remote controller not only can remotely control the channel selection and other functions of digital TV, also can dial and answer VoIP. Therefore, the present invention can efficiently combine two digital applications of digital TV and VoIP so as to save the expense and also the space.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A VoIP communication remote control system, comprising:
a network signal processing unit for retrieving a network data packet from an Internet;
a central processing unit connected to the network signal processing unit for obtaining an encoded visual signal and an encoded income-call data stream after de-packeting the network data packet;
an encode/decode module connected to the central processing unit for generating an image data stream and an audio data stream after decoding the encoded visual signal;
a medium playing unit connected to the encode/decode module for receiving and playing the image data stream and the audio data stream;
a wireless module connected to the central processing unit for wirelessly outputting the encoded income-call data stream; and
a remote controller having a speech receive/transmit unit, a data conversion unit, a control unit and a wireless module, wherein the remote controller wirelessly receives the encoded income-call data stream, the encoded income-call data stream is decode by the data conversion unit and then transmitted to the speech receive/transmit unit for playing, the control unit wirelessly transmits a control command to the central processing unit through the data conversion unit, and according to the control command, the central processing unit controls the medium playing unit through the encode/decode module.

2. A system as claimed in claim 1, wherein the speech receive/transmit unit of the remote controller retrieves a response signal, the response signal is converted into a response data stream after being encoded by the data conversion unit, the remote controller wirelessly transmits the response data stream to the central processing unit, and after the central processing unit packets the response data stream, it is transmitted to the internet through the network signal processing unit for achieving the VoIP communication.

3. A system as claimed in claim 1, wherein the network signal processing unit is an Ethernet interface for retrieving the encoded visual signal from the internet.

4. A system as claimed in claim 1, wherein the network signal processing unit is an asynchronous serial interface for retrieving the encoded visual signal from the internet.

5. A system as claimed in claim 1, wherein the encode/decode module implements a speech compression technology and an image compression technology on the visual signal for decoding so as to generate the image data stream and the audio data stream.

6. A system as claimed in claim 1, wherein the image data stream and the audio data stream are analog data.

7. A system as claimed in claim 1, wherein the image data stream and the audio data stream are digital data.

8. A system as claimed in claim 5, wherein the image data stream and the audio data stream are wirelessly outputted to the remote controller.

9. A system as claimed in claim 8, wherein the remote controller comprises a display unit for displaying the image data stream transmitted thereto through the data conversion unit.

10. A system as claimed in claim 8, wherein the audio data stream is transmitted to the speech receive/transmit unit through the data conversion unit for playing.

11. A system as claimed in claim 1, wherein the remote controller utilizes a character input unit to edit a character data stream and wirelessly transmits the character data stream to the central processing unit, and after the central processing unit packets the character data stream, it is transmitted to the Internet through the network signal processing unit so as to achieve an instant messenger.

12. A system as claimed in claim 1, wherein the network signal processing unit is connected to the central processing unit, the network signal processing unit, the central processing unit and the encode/decode module together composing a set top box.

13. A system as claimed in claim 1, wherein the medium playing unit is a digital TV.

14. A remote controller used in a VoIP communication remote control system for wirelessly communicating data with a terminal STB (Set Top Box) as well as dialing VoIP and remotely controlling digital TV, comprising:
a data conversion unit for wirelessly communicating data with the STB and executing a data conversion;
a speech receive/transmit unit connected to the data conversion unit for receiving and playing a income-call data stream as well as retrieving a response message from outside and transmitting to the data conversion unit;
a control unit connected to the data conversion unit for outputting a remote command to the data conversion unit;
a display unit connected to the data conversion unit for receiving and displaying an image data stream from the data conversion unit;
a character input unit connected to the control unit for outputting a character data stream and transmitting thereof to the data conversion unit through the control unit; and
a wireless module connected to the data conversion unit for wirelessly communicating data with a wireless module of a central processing unit.
